(19) United States
(12) Patent Application Publication
(10) Pub. No.: US 2026/0277822 A1
(43) Pub. Date: Sep. 17, 2026

(54) CONTROLLER FOR MEMORY EXPANSION, MEMORY EXPANSION DEVICE, AND DATA PROCESSING METHOD THEREFOR

(71) Applicant: POSTECH RESEARCH AND BUSINESS DEVELOPMENT FOUNDATION, Pohang-si (KR)

(72) Inventors: Gwang Sun KIM, Pohang-si (KR); Hyung Kyu HAM, Pohang-si (KR); Jeong Min HONG, Pohang-si (KR)

(73) Assignee: POSTECH RESEARCH AND BUSINESS DEVELOPMENT FOUNDATION, Pohang-si (KR)

(21) Appl. No.: 19/664,804

(22) Filed: Apr. 30, 2026

Related U.S. Application Data
(63) Continuation of application No. PCT/KR2024/013322, filed on Sep. 4, 2024.

(30) Foreign Application Priority Data
Oct. 31, 2023 (KR) 10-2023-0148584
Feb. 27, 2024 (KR) 10-2024-0028438

(51) Int. Cl. G06F 12/1027; G06F 9/30; G06F 13/16

(52) U.S. Cl. CPC G06F 12/1027; G06F 9/30043; G06F 13/1668

(57) ABSTRACT

Disclosed is a controller for memory expansion, which: receives a request transmitted from a host to a memory device; determines, based on the address of the memory device included in the request, whether the request corresponds to a memory-related first request distinguished from a read request and a write request; if the request is the first request, identifies the type of the first request based on the address of the memory device included in the request; and, if the request is the first request, executes the identified first request based on arguments included in the request.

### CROSS-REFERENCE TO RELATED APPLICATIONS

This application is a continuation of PCT/KR2024/013322 filed on Sep. 4, 2024 which claims priority to Korean Patent Application No. 10-2023-0148584 filed on Oct. 31, 2023 and Korean Patent Application No. 10-2024-0028438 filed on Feb. 27, 2024, with the Korean Intellectual Property Office (KIPO), the entire contents of each of which are hereby incorporated by reference for all purposes.

### BACKGROUND

### 1. Technical Field

The present disclosure relates to a memory expansion controller, a memory expansion device, and a data processing method therefor, and particularly to a technology for general-purpose near data processing having low overhead for a CXL memory expansion device.

### 2. Related Art

The content described in this section merely provides background information for the present embodiment and does not constitute the related art.

Compute Express Link (CXL) is emerging as a new interconnect standard widely adopted for high-performance communication among processors, accelerators, and memory expansion devices of a system.

A CXL memory expansion device may cost-effectively expand total system memory for various workloads requiring large-capacity memory. Although additional latency and limited bandwidth of a CXL interface may significantly affect latency-sensitive and bandwidth-intensive workloads, near data processing (NDP) of the CXL memory expansion device may provide a substantial opportunity to effectively address the problem. A computing-bound workload or a workload having a small working set fitting into an on-chip cache may be executed more efficiently at a host. Memory-bound workloads inherently have low arithmetic intensity (for example, FLOPs/byte) because memory-bound workloads tend to perform little computation for each accessed datum.

For bandwidth-intensive workloads exhibiting a high memory traffic load, a GPU is currently the most widely used device for acceleration. A common pattern of executing such workloads on a GPU is to assign each thread to particular data of a large-scale (multidimensional) array using a Single-Program Multiple-Data (SPMD) model. At a beginning of a kernel, each thread calculates an address of assigned data using a linear equation of a thread block ID, a block size, and a thread ID. However, address generation may occupy a significant portion of dynamic instruction counts in various GPU workloads.

A CXL standard shares a physical layer of a PCIe standard and protocol and defines three protocols. CXL.io is functionally identical to PCIe and is used for device discovery, enumeration, and management. CXL.cache allows a CXL device to access host memory through a cache coherence protocol. CXL.mem enables memory expansion through CXL. In particular, CXL.mem is a memory-semantic protocol enabling a processor to access data of a CXL memory expansion device by executing load/store instructions while providing lower latency than CXL.io.

A CXL specification also defines three device types based on supported protocols. In all types, CXL.io should be supported by default for device management. A first type of device is a memoryless accelerator (for example, a smart NIC) using CXL.cache. A second type of device is a cache-coherent accelerator having memory (for example, a GPU or FPGA) using CXL.cache and CXL.mem. A third type of device is a memory expansion device supporting CXL.mem.

When CXL.mem is used, a host can access a CXL memory expansion device using a Host Physical Address (HPA). The memory of the CXL memory expansion device is managed by a host processor and may be referred to as Host-managed Device Memory (HDM). A third-type CXL memory expansion device may use an HDM-H (host-only coherent) coherence model or an HDM-DB (device coherent using back-invalidation) coherence model. HDM-H is intended for a passive memory expansion device that does not manipulate memory exposed to a host. In contrast, HDM-DB assumes that a Device Coherence Agent (DCOH) having a snoop filter in the CXL memory expansion device tracks HDM caching of the host and performs back-invalidation (BI) when necessary. Accordingly, HDM-DB is suitable for a CXL memory expansion device having near data processing (NDP) capability, and the present disclosure assumes the HDM-DB model. The CXL memory expansion device may perform BI with respect to a host cache, but performance may degrade if BI occurs frequently during NDP.

CXL 3.0 also supports direct Peer-to-Peer (P2P) access allowing a CXL device to directly access HDM of another CXL device through a CXL switch. Routing by the switch is performed using HDM decoder registers. This capability may be useful for NDP of multiple CXL memory expansion devices. For virtual-to-physical address translation of a CXL device, Address Translation Service (ATS) defined in PCIe may be used to obtain translation information from a host. However, several microseconds of latency may occur due to protocol overhead and page table walks of the host. To reduce overhead, the device may include an Address Translation Cache (ATC) storing recently used translation information. When a page table is updated, the host can invalidate the ATC of the device to prevent incorrect translation. Accordingly, frequent use of an address translation service through a CXL.io protocol can cause high performance overhead.

Meanwhile, CXL-PNM of Samsung Electronics Co., Ltd. performs operations accelerating execution of a generative language model by mounting a computing unit in CXL memory. A matrix multiplication operation is offloaded through the CXL.io protocol.

CXL-ANNS accelerates approximate nearest neighbor search operations for near data processing (NDP) in a CXL-based memory device.

When computation offloading is performed using an existing protocol such as CXL.io or PCIe, multiple software and hardware steps are involved, thereby generating substantial communication overhead with a host processor. Such overhead may become particularly large in fine-grained offloading, and therefore reduction of overhead is important.

A conventional NDP architecture is limited in supporting general-purpose operations. The conventional NDP architecture is designed to accelerate a specific application, and therefore flexibility and scalability for various applications are limited.

When existing GPU cores and CPU cores are used for NDP, cost and power consumption may increase, and memory-intensive workloads cannot be executed cost-effectively.

Meanwhile, an approach of adding a new packet format by extending an existing standard has a problem in that the approach cannot be used in a host processor supporting only the existing standard.

### SUMMARY

The present disclosure provides a memory expansion controller, a memory expansion device, and a data processing method therefor capable of reducing communication overhead.

The present disclosure provides M²NDP (Memory-Mapped NDP) to enable general-purpose near data processing (Near Data Processing, NDP) in a CXL memory expansion device.

The present disclosure provides an architecture based on an unmodified CXL.mem protocol such that modification of host processor hardware is not required.

The present disclosure provides a memory expansion device providing M²func (Memory-Mapped Function) and M²μthr (Memory-Mapped Microthread) functions.

The present disclosure provides a controller and a memory expansion device enabling an NDP kernel to effectively avoid cold DRAM-TLB (DRAM-Translation Lookaside Buffer) misses causing long latency in ATS through proposed OS support for DRAM-TLB preload using M²func.

The present disclosure provides a controller and a memory expansion device capable of executing various general-purpose operations considering cost efficiency and programmability.

The present disclosure provides a controller and a memory expansion device enabling a μthread to initiate data access without redundant address calculation performed across all threads of a GPU warp by using one of input data arrays of a data-parallel workload as a μthread pool region.

The present disclosure provides an M²μthr function capable of achieving higher operation unit utilization than a GPU through fine-grained resource management.

According to one aspect of the present disclosure, a memory expansion controller may receive a request transmitted from a host to a memory device, and determine, based on an address of the memory device included in the request, whether the request corresponds to a memory-related first request distinguished from a read request and a write request; identify, based on the request being the first request, a type of the first request based on the address of the memory device included in the request; and execute, based on the request being the first request, the identified first request based on an argument included in the request.

According to exemplary embodiments, after determining that the request corresponds to the first request, based on an additional read request for an address of the first request being determined to be received, the memory expansion controller may transmit, to the host, a processing status of the first request stored at the address of the first request in the memory device.

According to exemplary embodiments, the controller may include a packet filter, an address region for distinguishing the first request may be allocated and stored in the packet filter, and the packet filter may determine that the request corresponds to the first request based on an address included in the request being included in the address region.

According to exemplary embodiments, a predetermined protocol may be used based on allocating, to the packet filter, the address region for distinguishing the first request and receiving the request.

According to exemplary embodiments, a predetermined first protocol from the host may be used based on allocating, to the packet filter, the address region for distinguishing the first request, and a predetermined second protocol may be used based on receiving the request from the host.

According to exemplary embodiments, the controller may include an NDP controller configured to execute the first request and a plurality of NDP units controlled by the NDP controller. Based on the first request being a kernel launch request, the NDP units may generate a plurality of microthreads mapped to different addresses of a first region (base&bound) of virtual memory, and each microthread may execute an operation on a mapped memory address.

According to exemplary embodiments, all microthreads executed within any NDP unit from among the plurality of NDP units may share data with each other through at least one on-chip scratchpad memory from among on-chip scratchpad memories included in each of the plurality of NDP units.

According to exemplary embodiments, the controller may further include a DRAM-TLB configured to convert a virtual address of virtual memory into a physical address of the memory device. Based on the request corresponding to a DRAM-TLB preloading request from among the types of the first request, the DRAM-TLB may be used by preloading the DRAM-TLB entry into the DRAM-TLB.

According to one aspect of the present disclosure, a memory expansion device may include a memory device and a controller arranged or disposed between a host and the memory device and including a plurality of NDP units. Based on the controller receiving a kernel launch request, the NDP units may generate a plurality of microthreads mapped to different addresses of a first region (base&bound) of virtual memory, each microthread may execute an operation on a mapped memory address, and a result of the execution may be stored at a result storage address defined in a kernel of the memory device.

According to exemplary embodiments, all microthreads executed within any NDP unit from among the plurality of NDP units may share data with each other through at least one on-chip scratchpad memory from among on-chip scratchpad memories included in each of the plurality of NDP units.

According to exemplary embodiments, the controller may receive a request transmitted from the host to the memory device, determine, based on an address of the memory device included in the request, whether the request corresponds to a memory-related first request distinguished from a read request and a write request, identify, based on the request being the first request, a type of the first request based on the address of the memory device included in the request, and execute, based on the request being the first request, the identified first request based on an argument included in the request.

According to exemplary embodiments, the NDP units may further include a DRAM-TLB configured to convert a virtual address of virtual memory into a physical address of the memory device. Based on the request corresponding to a DRAM-TLB preloading request from among the types of the first request, the DRAM-TLB may be used by preloading the DRAM-TLB.

According to one aspect of the present disclosure, a data processing method for a memory expansion device may include receiving, by a controller, a request transmitted from a host to a memory device; determining, based on an address of the memory device included in the request, whether the request corresponds to a memory-related first request distinguished from a read request and a write request; identifying, based on the request being the first request, a type of the first request based on the address of the memory device included in the request; and executing, based on the request being the first request, the identified first request based on an argument included in the request.

According to exemplary embodiments, the method may further include determining, by the controller, that an additional read request for an address of the first request is received after determining that the request corresponds to the first request, and transmitting, by the controller, to the host, a processing status of the first request stored at the address of the first request in the memory device.

According to exemplary embodiments, the method may further include allocating and storing, by the controller, an address region for distinguishing the first request in the controller, and the determining may include determining that the request corresponds to the first request based on an address included in the request being included in the address region.

According to exemplary embodiments, a predetermined protocol may be used based on allocating, to the packet filter, the address region for distinguishing the first request and receiving the request.

According to exemplary embodiments, allocating and storing the address region for distinguishing the first request may include using a predetermined first protocol from the host, and receiving the request from the host may include using a predetermined second protocol.

According to exemplary embodiments, based on the first request corresponding to a kernel launch request, the method may further include controlling, by the controller, a plurality of NDP units included in the controller to generate a plurality of microthreads mapped to different addresses of a first region (base&bound) of virtual memory, and controlling, by the controller, each microthread to execute an operation on a mapped memory address.

According to exemplary embodiments, all microthreads executed within any NDP unit from among the plurality of NDP units may share data with each other through at least one on-chip scratchpad memory from among on-chip scratchpad memories included in each of the plurality of NDP units.

According to exemplary embodiments, based on the request corresponding to a DRAM-TLB preloading request from among the types of the first request, the method may further include preloading, by the controller, the DRAM-TLB, and the DRAM-TLB may be used to convert a virtual address of virtual memory into a physical address of the memory device.

According to the present disclosure, a memory expansion controller, a memory expansion device, and a data processing method therefor capable of reducing communication overhead may be provided.

According to the present disclosure, M²NDP may be provided to enable general-purpose NDP in a CXL memory expansion device.

According to the present disclosure, an architecture based on an unmodified CXL.mem protocol not requiring modification of host processor hardware may be provided.

According to the present disclosure, a memory expansion device providing M²func and M²μthr functions may be provided. M²func may support low-overhead NDP offloading and management from a host processor through CXL.mem to overcome high overhead of CXL.io for fine-grained NDP offloading while maintaining standard compatibility. M²μthr may implement lightweight FGMT using RISC-V including a vector extension and may reduce redundant address calculation overhead compared to a SIMT-dedicated GPU while reducing DRAM traffic through a wide on-chip scratchpad memory region for cost-efficient NDP. In addition, resource waste caused by thread-block granularity resource allocation may be prevented through fine-grained μthread generation.

According to the present disclosure, an NDP kernel may effectively avoid cold DRAM-TLB misses causing long latency in ATS through proposed OS support for DRAM-TLB preloading using M²func.

According to the present disclosure, a controller and a memory expansion device capable of executing various general-purpose operations considering cost efficiency and programmability may be provided. Accordingly, a controller and a memory expansion device having improved data processing capability may be provided. Through a cost-efficient architecture, processing time may be improved and costs of energy and hardware configuration may be reduced in a large-scale cloud system and a large-scale computation processing system.

According to the present disclosure, a controller and a memory expansion device enabling a μthread to initiate data access without redundant address calculation performed across all threads of a GPU warp may be provided by using one of input data arrays of a data-parallel workload as a μthread pool region.

According to the present disclosure, higher operation unit utilization than a GPU may be achieved through fine-grained resource management using the M²μthr function.

### BRIEF DESCRIPTION OF THE DRAWINGS

FIG. 1 is a diagram illustrating a configuration of a memory expansion device according to an exemplary embodiment of the present disclosure.

FIG. 2 is a diagram illustrating M²func according to an exemplary embodiment of the present disclosure.

FIG. 3 illustrates, in a table form, predefined NDP management functions for various offsets based on an M²func region according to an exemplary embodiment of the present disclosure.

FIG. 4 illustrates a timeline comparing NDP offloading using CXL.io or M²func according to an exemplary embodiment of the present disclosure.

FIG. 5 illustrates a comparison table of architectures among a CPU, a GPU, and M²NDP according to an exemplary embodiment of the present disclosure.

FIG. 6 is a graph illustrating a ratio of active threads executed in an SM or an NDP unit over time for a main kernel of a pagerank benchmark according to an exemplary embodiment of the present disclosure.

FIG. 7 illustrates a microarchitecture of an NDP unit according to an exemplary embodiment of the present disclosure.

FIG. 8 is a diagram illustrating a structure of an NDP kernel according to an exemplary embodiment of the present disclosure.

FIG. 9 is a diagram illustrating a system using M²func according to an exemplary embodiment of the present disclosure.

FIG. 10 is a diagram illustrating a system using M²func according to another exemplary embodiment of the present disclosure.

FIG. 11 is a flowchart illustrating a data processing method for a memory expansion device using M²func according to an exemplary embodiment of the present disclosure.

FIG. 12 is a diagram illustrating a system using only M²μthr without using M²func according to an exemplary embodiment of the present disclosure.

FIG. 13 is a diagram illustrating a case of using only M²μthr without using M²func according to an exemplary embodiment of the present disclosure.

FIG. 14 is a flowchart illustrating a data processing method for a memory expansion device using M²μthr according to an exemplary embodiment of the present disclosure.

FIG. 15 is a conceptual diagram illustrating an example of a generalized controller, a memory expansion device, or a computing system capable of performing at least some of processes of FIGS. 1 to 14.

### DETAILED DESCRIPTION

In addition to the above objects, another objects and features of the present disclosure will become more apparent through the description of exemplary embodiments with reference to the accompanying drawings.

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, A, B, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminologies are used herein for the purpose of describing particular exemplary embodiments only and are not intended to limit the present disclosure. The singular forms include plural referents as well unless the context clearly dictates otherwise. Also, the expressions “comprises,” “includes,” “constructed,” “configured” are used to refer a presence of a combination of stated features, numbers, processing steps, operations, elements, or components, but are not intended to preclude a presence or addition of another feature, number, processing step, operation, element, or component. The word “exemplary” is used to mean serving as an example or illustration. Embodiments are example embodiments.

Unless defined otherwise, all terms used herein, including technical or scientific terms, have the same meaning as commonly understood by those of ordinary skill in the art to which the present disclosure pertains. Terms such as those defined in a commonly used dictionary should be interpreted as having meanings consistent with their meanings in the context of related literatures and will not be interpreted as having ideal or excessively formal meanings unless explicitly defined in the present application.

Hereinafter, exemplary embodiments of the present disclosure will now be described in detail with reference to the accompanying drawings. In the drawings, the same components may be designated by the same reference numerals to facilitate overall understanding of the disclosure, and duplicate descriptions thereof will be omitted for simplicity.

A major use case of CXL is memory expansion through a memory-semantic CXL.mem protocol enabling low-latency remote memory access through load/store instructions. The latency of CXL.mem is known to be significantly lower than the latency of PCIe and comparable to cross-socket NUMA latency. Accordingly, memory capacity of a host may be increased cost-effectively beyond limited DIMM slots. Such capability may be particularly useful for workloads having large memory spaces, including large language models, big data, and graph analytics. CXL is already supported in mainstream CPU products, and several CXL memory prototypes having a capacity of up to 512 GB and bandwidth (BW) of PCIe 5.0 have been announced.

However, a CXL link between a host and a device may become a bottleneck for bandwidth-intensive applications because link BW is lower than internal BW within a CXL memory expansion device. In addition, memory access through CXL.mem causes additional latency through a protocol stack, whereas latency overhead may be avoided within the CXL memory expansion device.

Accordingly, compared with directly accessing data of a CXL memory expansion device to perform computation in a host processor, performing near data processing (NDP) in the CXL memory expansion device may provide significant speedup for memory-bound workloads having low arithmetic intensity. However, previous approaches implement application-specific NDP hardware logic in a CXL memory expansion device. Since a primary motivation of the CXL memory expansion device is to increase system memory capacity cost-effectively, introducing various ASICs for various NDP targets may not be a practical approach due to increased overall area and NRE cost. Although an FPGA may be tuned for a target workload, a programmability issue exists. Meanwhile, using general-purpose CPU or GPU cores for NDP in a CXL memory expansion device may significantly increase cost of the CXL memory expansion device and therefore may not be suitable for cost-effective memory expansion having NDP capability.

A CXL memory expansion device adopted in recent systems may provide a substantial opportunity for performance improvement by performing near data processing (NDP) in the CXL memory expansion device. However, since the CXL memory expansion device is proposed as a cost-effective alternative to using larger or more CPUs for larger memory capacity, industrial feasibility of such an NDP architecture depends on reducing overhead while supporting general-purpose computing in order to avoid high costs associated with generation of various ASICs.

To reduce overhead, the present disclosure may provide a low-overhead general-purpose NDP architecture for CXL memory referred to as M²NDP (Memory-Mapped NDP).

Since the present disclosure targets workloads having large memory footprints not fitting in an on-chip cache of a host processor, it is assumed that HDM data is not cached in a host when NDP starts. If necessary, the host may quickly flush HDM data from the cache using hardware support of a current CPU.

For memory mapping of the CXL memory expansion device, fine-grained 256 B interleaving may be assumed using hashing across memory channels for load balancing within the CXL memory expansion device. When multiple CXL memory expansion devices exist in a system, each page (4 KB or 2 MB) may be assumed to be mapped to a single CXL memory expansion device as in current NUMA or multi-GPU systems.

The present disclosure targets memory-bound workloads (bandwidth-bound or latency-bound workloads) having large memory footprints not fitting in an on-chip cache of a host processor.

The present disclosure relates to computer architecture, memory systems, and large-scale data processing.

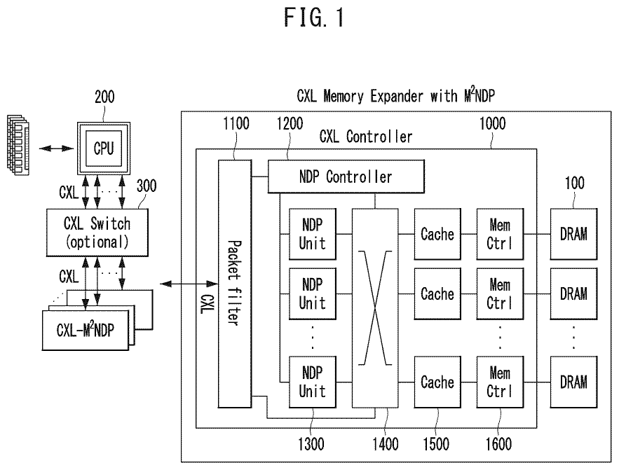

FIG. 1 is a diagram illustrating a configuration of a memory expansion device according to an exemplary embodiment of the present disclosure.

The memory expansion device, CXL Memory Expander with M²NDP, may include a CXL controller 1000 and a memory device (for example, a plurality of DRAMs) 100 connected to the CXL controller 1000. In the exemplary embodiment of FIG. 1, the memory expansion device is illustrated as including DRAM, but an SSD, etc., or the like may be connected to the CXL controller instead of the DRAM.

A host (CPU) 200 may access the memory expansion device through CXL.io and CXL.mem protocols.

The host 200 may be connected to any memory expansion device among a plurality of memory expansion devices through a CXL switch 300 (link).

The CXL controller 1000 may include a packet filter 1100, an NDP controller 1200, a plurality of NDP units 1300, a cross bar 1400, a plurality of caches 1500, and a plurality of memory controllers 1600.

Each of the plurality of NDP units 1300 may be connected to any cache among the caches 1500 via the cross bar 1400. When the NDP unit 1300 is connected to the cache, the NDP unit 1300 may access DRAM 100 through the memory controller 1600 matching the cache.

NDP of the memory expansion device may significantly improve system performance of various applications, but conventional technologies propose application-specific logic, and thus high NRE and hardware area costs occur when the conventional technologies support various applications. General-purpose NDP may potentially overcome such limitations, but when existing CPU cores or GPU cores are used for NDP, certain technologies are not necessarily optimized for memory-bound workloads, and thus high costs may still occur. That is, the certain technologies are designed for computing-bound workloads and memory-bound workloads.

In order to achieve high performance and cost efficiency of general-purpose NDP, the present disclosure proposes M²NDP (Memory-Mapped Near-Data Processing) of a CXL memory expansion device referred to as CXL-M²NDP described above. In the present disclosure, the CXL memory expansion device may be referred to as a memory expansion device, CXL memory, or CXL-M²NDP. The M²NDP may be configured with two mechanisms, that is, (1) M²func (Memory-Mapped NDP) for low-overhead NDP management and offloading based on unmodified CXL.mem and (2) M²μthr (Memory-Mapped μthreading) for a cost-efficient NDP microarchitecture. Specifically, the M²func is a CXL.mem-compatible low-overhead communication mechanism between a host processor 200 of the CXL memory expansion device and the NDP controller 1200. The M²μthr may enable a low-cost NDP device design for general-purpose computing by introducing lightweight microthreads (μthreads) supporting concurrent execution of an NDP kernel while minimizing resource waste.

This is implemented in a controller chip of a CXL memory expansion device supporting general CXL.mem transactions.

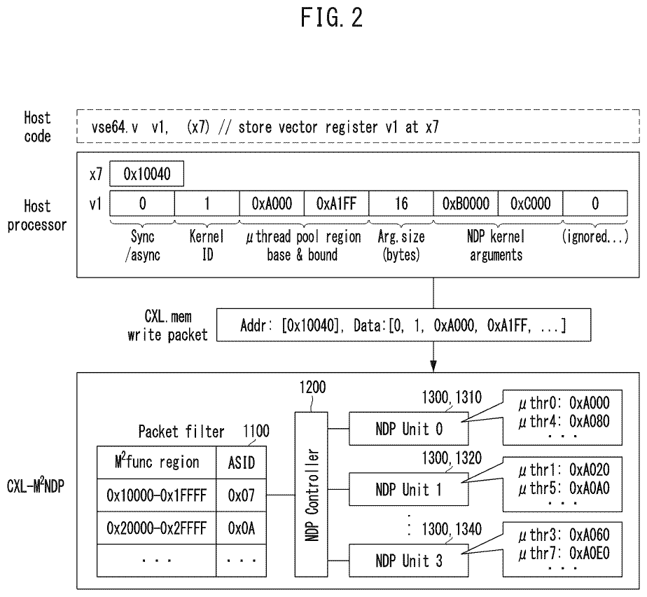

FIG. 2 is a diagram illustrating M²func according to an exemplary embodiment of the present disclosure.

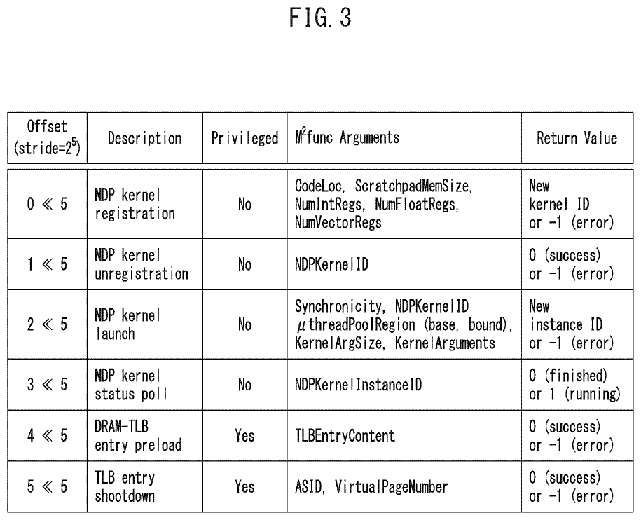

FIG. 3 illustrates, in a table form, predefined NDP management functions for various offsets based on an M²func region according to an exemplary embodiment of the present disclosure.

Fields of the table of FIG. 3 may include Offset, Description, Privileged, M²func arguments, and Return Value.

Hereinafter, descriptions will be provided with reference to FIGS. 1 to 3.

In the present disclosure, unmodified CXL.mem protocol may be used. Conventionally, in order to utilize NDP for fine-grained computation offloading as well as coarse-grained offloading, communication latency between a host and CXL-M²NDP should be minimized. Although the CXL.mem protocol provides short latency, a standard defines only a packet type for general CXL memory access and cannot be directly used for other communication. When CXL.mem is extended to support a custom packet type, compatibility among host processors is damaged and an NDP architecture is not widely adopted. In contrast, CXL.io may be used for arbitrary communication, but CXL.io incurs higher latency in a protocol stack and requires context switching to an OS for privileged I/O device communication, and thus latency further increases.

Accordingly, M²func of the present disclosure may be used to enable low-overhead and flexible communication between a host and CXL-M²NDP using unmodified CXL.mem. That is, a portion of physical memory space of the memory expansion device is reserved for host communication and is referred to as an M²func region. In order to distinguish two uses of a packet, that is, general memory access (a read request/a write request) or an M²func invocation, a packet filter 1100 is introduced at an input port of the memory expansion device to inspect all packets entering the memory expansion device and determine, based on a packet address, whether a packet is to be interpreted as general memory access or an M²func invocation.

Hereinafter, a method of distinguishing the two uses through the packet filter will be described in detail.

FIG. 2 illustrates host code, a host processor, and CXL-M²NDP.

The host code is a general vector instruction code executing a vector store instruction storing a value of a v1 vector register at an address stored in a scalar register (for example, x7).

In a host processor box, a value of an x7 register points to an address 0x10040. A v1 register stores content to be written, for example, information required for kernel execution.

When data is transmitted to CXL-M²NDP, that is, the memory expansion device, through a general vector write instruction via a CXL.mem write packet (Addr:[0x10040], Data:[0, 1, 0xA000, 0xA1FF, . . . ]), the packet filter 1100 of the memory expansion device inspects an address region of the CXL.mem write packet (for example, an address value previously stored in x7), and when an address of the write packet is included in an address region registered in advance in the packet filter 1100, a function registered in advance may be executed.

Specifically, as shown in a table of the packet filter 1100 of FIG. 2, an address region for distinguishing the first request may be allocated and stored in the packet filter 1100. Fields of the table may include an M²func region field and an ASID field. In the M²func region field, regions may be distinguished, for example, as 0x10000-0x1FFFF, 0x20000-0x2FFFF, etc., or the like. An ASID (Address Space Identifier) may be matched and stored in an address region of each record.

For example, in the write packet, since an x7 address is 0x10040, the x7 address is included in a first region (that is, a first record) of the M²func region. Therefore, the write packet corresponds to a memory-related request for executing functions registered in advance (that is, an M²func invocation), not a write packet accessing memory itself (that is, not a general memory access).

In a table illustrating an M²func region of FIG. 2, a first record defines 0x10000-0x1FFFF. As shown in FIG. 2 and FIG. 3, for example, 0x10000 is matched to an offset 0<<5, 0x10020 is matched to an offset 1<<5, and 0x10040 is matched to an offset 2<<5, and functions may be registered in advance in such a manner. In an exemplary embodiment of FIG. 2, since an address of a packet indicates 0x10040, the packet corresponds to an NDP kernel launch corresponding to an offset 2<<5, and arguments may include Synchronicity (Sync/async), NDPKernelID, μthreadPoolRegion (base, bound), KernelArgSize (bytes), and KernelArguments. A return value in this case may be a kernel instance ID or −1 indicating an error. The return value may be stored in an address of the packet, for example, an address 0x10040 of the memory device. Alternatively, in another exemplary embodiment, the return value may be stored in an address of the packet, for example, an address of a memory buffer inside a controller 1000.

For example, in a case of a kernel launch of FIG. 2, the kernel launch may correspond to a VectorAdd NDP kernel calculating C=A+B. Vectors A, B, and C may be arranged at 0xA000, 0xB000, and 0xC000, respectively. In this case, 0xA000, 0xB000, and 0xC000 may indicate address regions of virtual memory. Each μthread (μthr) may calculate a 32B (8×4B) partial vector output. In FIG. 2, other data path components are not illustrated for conciseness. In FIG. 2, in an actual implementation, μthreads using SIMD (Single Instruction, Multiple Data) operations and larger cross-lane placement intervals may be used. For example, μthreads of 32B units may be placed in larger 64B units among NDP units. For example, uthr0 and uthr1 of FIG. 2 may be placed in an NDP unit 1310, and uthr2 and uthr3 may be placed in an NDP unit 1320.

For example, in another exemplary embodiment, it may be assumed that an address region including 0x00FF0000 (or 0x00FF0020) is registered in advance in an M²func region of a packet filter of FIG. 2. An address 0x00FF0000 (or 0x00FF0020), which is an address of a write packet, may be matched to an offset 0 (or an offset 1<<5) in FIG. 3. Therefore, NDP kernel registration (or NDP kernel unregistration) corresponding to an offset 0<<5 (or an offset 1<<5) may be executed.

As illustrated in FIG. 3, an M²func invocation may include a function/procedure related to lifecycle management of an NDP kernel. For example, the M²func invocation may perform various functions including NDP kernel registration (offset 0<<5), NDP kernel unregistration (offset 1<<5), or NDP kernel launch (offset 2<<5), and execution of the functions may be performed by the NDP controller 1200. Registration or unregistration of an NDP kernel may refer to a procedure in which a table storing information on an NDP kernel to be registered/unregistered is stored in or deleted from a general memory such as SRAM (not shown) or DRAM 100.

Alternatively, as illustrated in FIG. 3, an M²func invocation may further include a function/procedure related to a special memory unit other than a general memory such as SRAM (not shown) or DRAM. For example, as illustrated in FIG. 3, a request for preloading an entry in a DRAM-TLB (Translation Lookaside Buffer) for converting a virtual address of virtual memory into a physical address of the memory device, and/or a request for TLB entry shootdown may be processed. According to an exemplary embodiment of the present disclosure, a request for preloading an entry in DRAM-TLB, a request for TLB entry shootdown, etc., or the like may be initiated by an entity having privileged authority. Although only functions from 0 to 5 are illustrated in FIG. 3, various additional functions may be registered in advance and used. That is, various functions may be invoked using addresses having different offsets based on an M²func region of a CXL.mem packet.

When a request received from the host 200 is a general memory access request, the packet filter 1100 may be connected to a crossbar 1400 to execute the request. For example, when the packet filter 1100 receives the general memory access request to DRAM, when an address of the request corresponds to a read request for data currently being processed while executing a kernel, an uncompleted result may be returned to the host 200, and when the address of the request corresponds to an address for data unrelated to the kernel execution, simple access to the data may be possible. That is, according to the present disclosure, DRAM access may be possible even during NDP processing such as kernel execution.

Meanwhile, the NDP controller 1200 may be implemented as a low-cost core similar to a microcontroller of a GPU. For M²func initialization, each user-level process of the host 200 allocates an M²func region that cannot be cached in the memory expansion device. An address range of the region may be inserted into the packet filter through CXL.io via a CXL memory driver. Once initialization is completed, CXL.io is no longer required for NDP, and CXL.mem may be used for both general read/write and NDP-related communication (M²func invocation). Alternatively, the address range of the region may be inserted into the packet filter using M²func through the CXL memory driver. In this case, CXL.io may not be used. In the present exemplary embodiment, when M²func is used, the present exemplary embodiment describes using CXL.mem, but implementation may also be performed based on other protocols similar to CXL, such as CCIX, etc., or the like.

As described above, in a case of an M²func invocation, a write request format is used, and an argument is included in a data write portion of a request. In order to transmit the request, a host process 200 executes a store instruction using a register holding the argument. A vector/SIMD register may be used to transmit multiple arguments up to a size of the vector register. Since the M²func region cannot be cached, a write bypasses a host cache. However, a response to the write request cannot include return value data of the NDP controller 1200 (that is, a return value for each function of FIG. 3) using CXL.mem. Therefore, a return value of a most recent function invocation by a current process is accessed using a subsequent read request for the same address. Since the return value is accessed through general memory access, the NDP controller 1200 stores the return value of the function in the corresponding memory address and processes the read request as general access. In order to maintain correct ordering, a fence instruction should exist between an M²func request and a read request in host code.

As described in an NDP kernel structure below, various NDP kernels may require various amounts of registers and scratchpad memory resources. Therefore, metadata should be specified when a kernel is registered. In addition, a kernel argument size should be specified so that arguments may be correctly extracted from a kernel launch packet. Metadata of registered NDP kernels is also stored in an M²func region of a current host process, and in addition to offsets used in FIG. 3, additional metadata is registered in advance and starts at predetermined positions. Therefore, the host may easily access kernel metadata in memory when necessary. Since a memory region of M²func is allocated per process, the memory region of M²func is protected from other processes by a virtual memory system of the host.

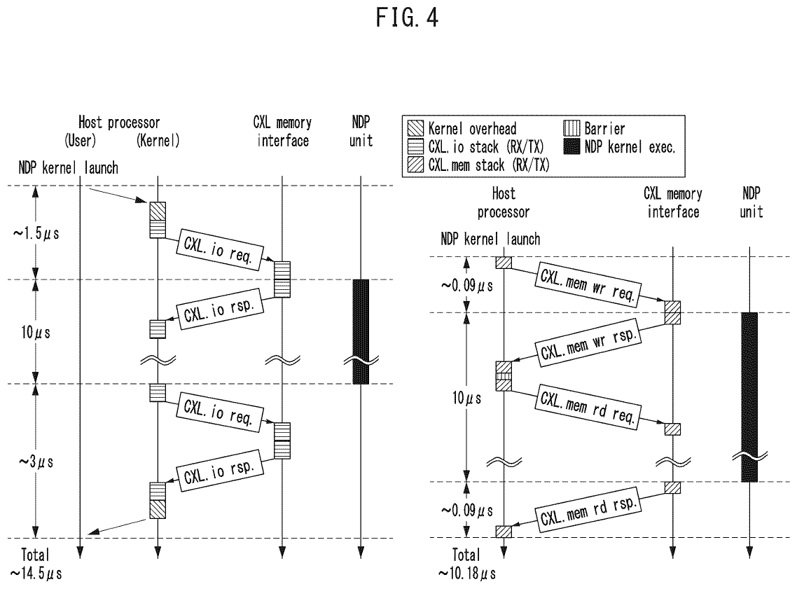

FIG. 4 illustrates a timeline comparing NDP offloading using CXL.io or M²func according to an exemplary embodiment of the present disclosure.

A timeline on a left side corresponds to a case using CXL.io, and a timeline on a right side corresponds to a case using M²func.

In this case, synchronous launch is performed and an NDP kernel execution time is assumed to be 10μs. In addition, 3μs latency is assumed for round-trip CXL.io/PCIe and kernel overhead, and 180 ns load-to-use latency is assumed for host CXL.mem access.

Compared with an NDP kernel launch using CXL.io causing context switching to a kernel and longer CXL.io protocol latency as shown in the timeline on the left side, a kernel launch using M²func is performed in user space and overall latency is lower as shown in the timeline on the right side. That is, about 42% speedup may be achieved for a 10 μs kernel when M²func is used compared with when CXL.io protocol is used. Although a separate CXL.mem read request (CXL.mem rd req) and a barrier (a barrier between a CXL.mem wr rsp and a CXL.mem rd req) are required, the separate CXL.mem read request and the barrier overlap with kernel execution. That is, although a barrier (or fence) may be considered as causing significant overhead, the overhead is hidden for a user because the overhead overlaps with an NDP kernel execution time as illustrated in FIG. 4, and therefore the overhead does not affect end-to-end NDP execution time from a user perspective. When an NDP kernel is extremely short, the barrier may not be completely hidden, but CXL.mem will still have shorter overall latency than CXL.io. The barrier may correspond to the fence instruction described above.

In the exemplary embodiment of FIG. 4, since the host 200 receives a read response (CXL.mem rd rsp) after an NDP kernel ends from the CXL memory expansion device, specifically, from the CXL controller 1000, as shown in FIG. 3, a synchronicity argument of kernel launch may be synchronous (sync). For example, as shown in FIG. 2 and FIG. 3, a synchronicity argument may have a value of “0” in a synchronous state and may have a value of “1” in an asynchronous state.

As described above, the present disclosure focuses on NDP offloading support using CXL.mem to minimize overhead, while the present disclosure does not exclude use of CXL.io to provide NDP management functions, for example, to register an address range of an M²func region in a packet filter. For a coarse-grained NDP kernel, CXL.io overhead may be well amortized over a long kernel runtime.

Hereinafter, NDP kernel launch will be described with reference to FIGS. 1 to 4.

Due to a low-overhead CXL.mem protocol, M²func may launch an NDP kernel with minimal overhead. An NDP kernel launch may be performed by invoking M²func corresponding to an offset 2<<5 of FIG. 3 using a store instruction generating a write request including kernel launch arguments as shown in FIG. 2. FIG. 3 illustrates M²func arguments and NDP kernel arguments together, and the M²func arguments are arguments for a kernel launch function and determine a kernel launch method, and the NDP kernel arguments are arguments directly used in an NDP kernel code. Large data for a kernel (for example, an array) may also be stored in a separate memory location of a CXL memory expansion device, and a pointer to the large data may be transmitted as an argument. Each NDP kernel instance may be connected to a virtual memory region for an input or output data array referred to as a μthread pool region, which is provided in a kernel launch invocation for NDP kernel launch, using an M²μthr mechanism. As shown in FIG. 4, after launching a kernel as a write packet using M²func, the NDP controller 1200 may always immediately transmit an acknowledge packet (CXL.mem wr rsp).

As shown in FIG. 4, the host 200 may have a memory fence (barrier) and a load instruction (CXL.mem rd req) for fetching a return value for a kernel launch function at the same M²func offset 2<<5. This differs in that when a CXL memory expansion device receives a write request from the host 200 for kernel launch, the CXL memory expansion device receives a read request from the host 200. However, a read response (CXL.mem rd rsp) including the return value may be transmitted to the host 200 differently based on a synchronicity argument provided in kernel launch (refer to FIG. 3). The return value is immediately returned in a case of asynchronous launch, but the return value may be returned after a kernel ends in a case of synchronous launch. The asynchronous launch may be useful when the host 200 performs other computation overlapping an NDP kernel. Then, the host 200 may confirm completion later through an M²func request (NDP kernel status poll) for an offset 3<<5 of FIG. 3.

In this case, three cases may exist for returning a return value for a kernel. A first case is a case in which a read packet is received and the kernel launch is an asynchronous kernel launch and a return value is immediately returned. A second case is a case in which a read packet is received and the kernel launch is a synchronous launch and a return value is returned after the kernel launch ends. A last case is a case in which a read packet is subsequently received after a write packet for the offset 3<<5 (NDP kernel status poll) is received, and in the last case, a return time point may also be determined based on synchronous or asynchronous. In the last case, since a return value cannot be transmitted to the host for a request of the write packet, a CXL controller may transmit the return value to the host when the CXL controller receives a request of the read packet. As shown in FIG. 3, in a case of the offset 3<<5 (NDP kernel status poll), a CXL controller may receive, from a host, a request of a write packet including NDPKernelInstanceID as an argument. When instances of multiple NDP kernels are being executed, the CXL controller may determine which kernel state is to be polled through the argument. The CXL controller stores a state of the determined kernel at an address of the write packet, and when the CXL controller receives a read packet, the CXL controller may return the state of the determined kernel stored at the address to the host.

When available resources of an NDP unit 1300 are insufficient for kernel launch due to another kernel currently being executed, a kernel launch request may be buffered and provided after a previous kernel is completed. Referring to the offset 2<<5 of FIG. 3, when a buffer is full, since a kernel launch which is an M²func request cannot be executed, a CXL controller 1000 may return −1 to the host 200 as a return value to indicate an error.

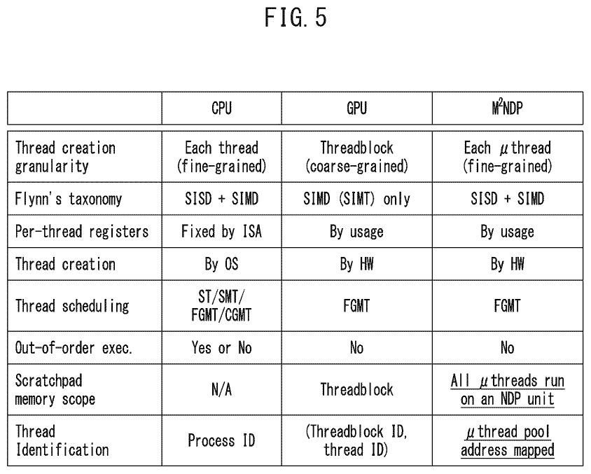

FIG. 5 illustrates a comparison table of architectures among a CPU, a GPU, and M²NDP according to an exemplary embodiment of the present disclosure.

For example, a GPU of FIG. 5 may be an NVIDIA GPU.

M²NDP may refer to the memory expansion device described above with reference to FIG. 1.

In the comparison table of FIG. 5, each row corresponds to thread creation granularity, Flynn's taxonomy, per-thread registers, thread creation, thread scheduling, out-of-order execution, scratchpad memory scope, and thread identification.

In order to maximize memory bandwidth utilization of an NDP kernel executed in a CXL memory expansion device, a large number of memory accesses should be performed concurrently to hide memory latency. Out-of-order cores may perform multiple memory accesses concurrently, but out-of-order cores are not suitable for cost-efficient NDP due to high control logic overhead.

Referring to thread creation granularity of a first row, CPU threads are generated per fine-grained each thread unit, GPU threads are generated per coarse-grained thread block unit, and threads of the present disclosure (M2NDP) are generated per fine-grained each microthread unit.

Referring to Flynn's taxonomy of a second row, CPUs and the present disclosure use a combination of SISD and SIMD, while a GPU uses only SIMD (SIMT).

Fine-Grained Multithreading (FGMT) may provide efficiently high concurrency particularly when a number of threads is high as in a GPU. However, SIMT-only execution of a GPU does not provide scalar operations (for example, loop variable management and address calculation), and thus threads perform redundant computation within a warp, and therefore inefficiency may occur.

Therefore, in order to efficiently support both scalar and SIMD operations, the present disclosure adopts a RISC-V ISA including vector extension (that is, RV64GV) and modifies the architecture so that there is no limitation in supporting M²μthr of the present disclosure based on concurrent FGMT. In particular, in the case of a CPU, since an OS performs thread generation and management, overhead may be significant when the number of threads is large, particularly when lifetimes of threads are short. For example, when a thread is generated in a modern OS, μs-scale delay occurs per thread.

Referring to a third row of the comparison table of FIG. 5, since a CPU thread requires an entire register set defined by the ISA, a register file cost may increase linearly according to the number of hardware threads. Meanwhile, since memory-bound workloads have lower arithmetic intensity, memory-bound workloads tend to require fewer registers than compute-bound workloads. Therefore, in the present disclosure, threads managed by hardware in a GPU style without an existing OS for a CPU are used, and when an NDP kernel is registered as in offset 0<<5 of FIG. 3, the number of registers for each thread is provided as designated by software (that is, a compiler) or a user, thereby reducing register file cost. For example, when five integer registers and three vector registers are designated, the kernel may use only x0-x4 registers and v0-v2 registers. In the present disclosure, such a type of thread may be referred to as a microthread (μthread) because resource usage of the thread is low.

Referring to a fourth row, in the case of a CPU, generation of a thread is performed by an OS. In contrast, generation of a μthread may be performed in hardware as quickly as in a GPU. In the present disclosure, on-chip scratchpad memory is introduced for efficient communication among μthreads of an NDP unit 1300.

Although similarities exist, μthreads of the present disclosure differ from GPU threads in several aspects in addition to differences in ISA. That is, while a GPU uses a SIMT-only GPU ISA, the present disclosure uses SISD+SIMD by a RISC-V ISA including vector extension for μthreads.

First, GPU threads are identified by multidimensional thread blocks and thread indices, whereas μthreads may be identified by an address mapped to a μthread pool region. As illustrated in FIG. 2, by using one of input data arrays of data-parallel workloads as a μthread pool region, a μthread may start data access without redundant address calculation performed across threads of a GPU warp, which may account for about 30% of dynamic instructions according to existing studies. Since the mapped address is provided as a base address and an offset pair, the offset may also be used to access other input/output data having different base addresses.

Second, as described above, while GPU threads are generated in coarse-grained thread block units, μthreads are generated in fine-grained units of individual threads. Coarse-grained thread generation may cause resource fragmentation and underutilization due to divergence among warps. That is, unused resources in completed warps of a thread block are not used until the entire thread block is completed and the resources are released for a next thread block.

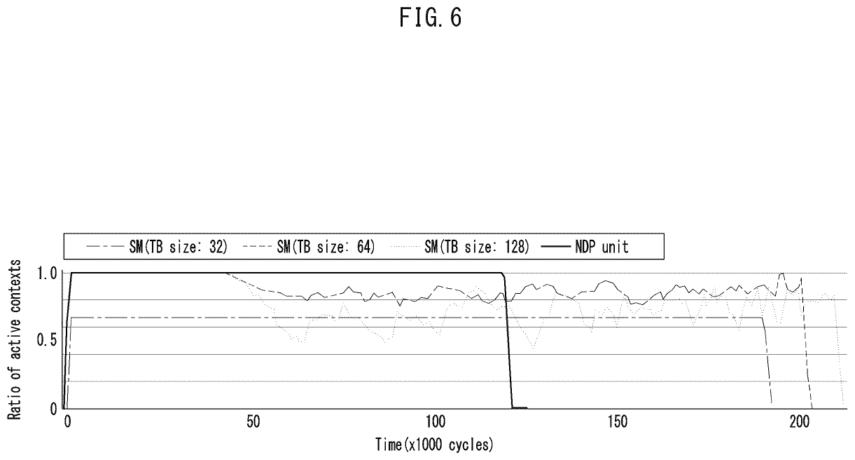

FIG. 6 is a graph illustrating a ratio of active threads executed in an SM or an NDP unit over time for a main kernel of a pagerank benchmark according to an exemplary embodiment of the present disclosure.

The SM may indicate a streaming multiprocessor of a GPU core.

A horizontal axis of the graph represents time (time (×1000 cycles)), and a vertical axis represents a ratio of active threads (contexts).

The graphs represent ratios of active threads for GPU SM (TB size: 32), GPU SM (TB size: 64), and GPU SM (TB size: 128), respectively, and a graph of an NDP unit of the present disclosure represents a ratio of μthreads of M²μthr.

A maximum number of thread blocks per SM limits an active warp ratio to 32 with respect to a thread block (TB) size.

For example, FIG. 6 shows that an active warp ratio of a GPU SM used for NDP varies between 0.5 and 1.0 over time according to a thread block size (TB size). In contrast, according to the present disclosure, since resources of completed μthreads are immediately released and become available for subsequent μthreads, resource utilization and performance/cost are improved. In some cases, resource utilization may be improved when a thread block size of a GPU is reduced, but it may be more difficult to effectively use CUDA shared memory because different thread blocks cannot share data through shared memory. As a result, global memory traffic may increase. By removing a thread block hierarchy, a necessity to optimize a thread block dimension which may significantly affect performance is also removed.

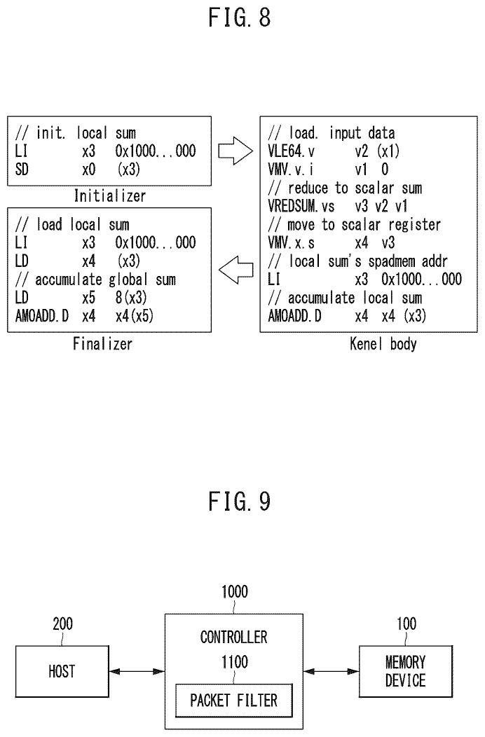

Third, a scope of on-chip scratchpad memory of an NDP unit 1300 is larger for μthreads than in CUDA. CUDA shared memory is not shared between thread blocks even when executed in the same SM. That is, even within the same core, when different thread blocks correspond to different thread blocks, values of shared memory cannot be referenced from each other. Therefore, for example, when histogram computation is performed, after execution of a thread block ends, data is stored in DRAM, and another thread block reads the data stored in DRAM, performs counting, and stores the data again in DRAM, and therefore memory traffic increases significantly. In contrast, according to the present disclosure, contents of scratchpad memory are shared across an entire NDP unit, scratchpad memory is initialized once before execution of all μthreads, and data stored in the scratchpad memory after execution of all μthreads may be stored in DRAM through a finalizer of FIG. 8. That is, all μthreads executed in the same NDP unit may share data through the on-chip scratchpad memory, thereby further reducing off-chip memory traffic.

A size of data associated with a μthread may be identical to or different from memory access granularity of a DRAM interface (for example, 64B in DDR5 or 32B in LPDDR5). For load balancing across NDP units 1300, μthreads are mapped to NDP units 1300 in an interleaved manner using memory access granularity. μthreads are executed simultaneously in a bulk synchronous parallel model without guaranteed order, similar to CUDA threads of a GPU kernel. Therefore, an NDP kernel should be written accordingly.

Meanwhile, referring to thread scheduling, a CPU may use ST/SMT/FGMT/CGMT schemes, and a GPU and M²NDP of the present disclosure use an FGMT scheme.

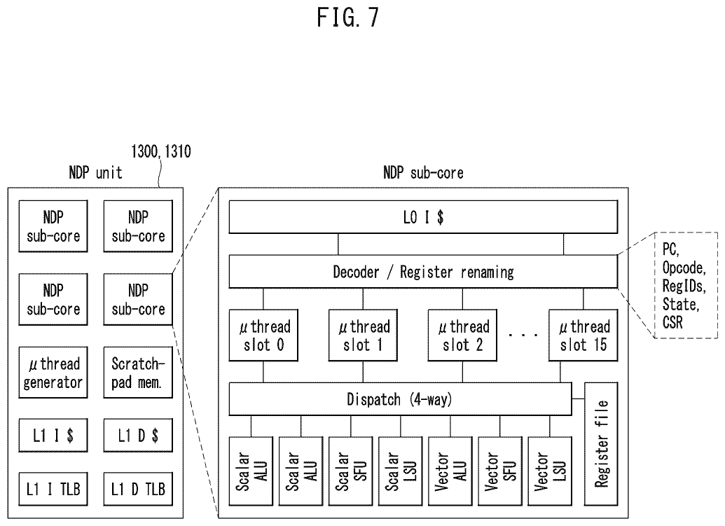

FIG. 7 illustrates a microarchitecture of an NDP unit according to an exemplary embodiment of the present disclosure.

An NDP unit 1300 is designed at low cost while supporting general-purpose computation.

The NDP unit 1300 may include a plurality of NDP sub-cores, a μthread generator, scratchpad memory (spadmem), an L1 instruction cache (L1 I $), an L1 data cache (L1 data $), an L1 instruction TLB (L1 I TLB), and an L1 data TLB (L1 D TLB). The scratchpad memory may also be referred to as on-chip scratchpad memory.

The NDP sub-core may include an L0 instruction cache (L0 I $), a decoder/register renaming unit, a plurality of microthread slots, a dispatch (4-way), a scalar ALU, a scalar SFU, a scalar LSU, a vector ALU, a vector SFU, a vector LSU, and a register file.

The L0 instruction cache may be a cache that first checks an instruction accessed by each NDP sub-core. When the instruction requested from the L0 instruction cache does not exist, an L0 cache controller may transmit a request for the instruction to the L1 instruction cache.

As shown in FIG. 2 and FIG. 7, when an NDP kernel starts, an NDP controller 1200 allocates a μthread slot and a register file resource to one of sub-cores of an NDP unit 1300 and instructs a μthread generator to generate μthreads corresponding to a size of data to be executed. The sub-core design is used to reduce complexity of a dispatch unit.

The microthread slot (μthread slot) may include a program counter (PC), an opcode and register IDs (RegIDs) of a currently decoded instruction, a state, and a configuration and status register (CSR) of RISC-V.

The register ID may include a first register ID required by the currently decoded instruction and a base ID designated for renaming registers to be used in the corresponding μthread. That is, the base ID may be a base (starting) ID for integer registers, floating-point registers, and vector registers.

Although base IDs that are register IDs used in respective μthreads indicate the same address, the base IDs are actually stored in different registers. Therefore, register IDs in actual hardware may be different. Accordingly, a process of matching a base ID to a hardware ID is required, and the process may be performed in the register renaming unit.

The state may store an execution-related state of a μthread (for example, ready, stall, etc.).

The base ID, that is, base register IDs, are determined when each μthread is generated and registers required for a kernel are allocated. A logical register is renamed to physical registers for access by simply adding a logical ID to the base ID. In addition, first two scalar registers having non-zero values (that is, x1 and x2) are initialized as an address and an offset of a μthread pool associated with the μthread. After a microthread slot is allocated to a μthread, a PC of the microthread slot is initialized to a kernel code location and fetches instructions through an instruction cache for execution. For example, the instruction cache may be an L0 instruction cache, and instructions may first be fetched by accessing the L0 instruction cache. When a miss occurs in the L0 instruction cache, an L1 instruction cache may be accessed.

In addition, the on-chip scratchpad memory may be used in each NDP device for sharing data among all μthreads executed in the same NDP unit. The scratchpad memory may be a separate memory space not address-mapped with DRAM 100. In the scratchpad memory, data to be shared among multiple threads may be stored in advance by a user.

For example, as shown in FIG. 2 and FIG. 7, all μthreads executed in “NDP unit 0” may share data through on-chip scratchpad memory included in “NDP unit 0”. All μthreads executed in “NDP unit 1” may share data through on-chip scratchpad memory included in “NDP unit 1”. For example, μthreads of “NDP unit 0” may share data with μthreads included in another NDP unit (for example, “NDP unit 1”) through on-chip scratchpad memory included in the other NDP unit. That is, μthreads of an arbitrary NDP unit may access scratchpad memories of other NDP units.

The scratchpad memory may be allocated for each NDP unit according to an amount designated by an NDP kernel.

Kernel arguments are also placed in the scratchpad memory after allocation of the microthread slot. The scratchpad memory is mapped to an unused region of a virtual memory layout and may be accessed using a general load/store. When a μthread accesses the scratchpad memory, an address may be added to a base address of the allocated scratchpad memory.

A load/store unit (LSU) for the scratchpad memory equipped with an atomic operation function is also provided to manipulate shared data (for example, reduction operations by multiple μthreads) within the NDP unit 1300. That is, the scratchpad memory may be provided for safe operations on shared data by multiple μthreads within the NDP unit. In order to prevent consistency problems, global memory atomicity is performed in a memory-side L2 cache (cache 1500 of FIG. 1). Address translation is performed using on-chip TLBs, a DRAM-TLB, and an ATS. The NDP unit 1300 may access all memory locations in a CXL memory expansion device of a system through on-chip and off-chip interconnections.

Without the above-described scratchpad memory, when a plurality of μthreads perform operations using the same value, all μthreads access, for example, DRAM 100. Since access to DRAM 100 takes longer than access to SRAM, access time may be reduced by using the scratchpad memory.

While instructions of a μthread are executed sequentially one by one, different μthreads independently issue instructions through FGMT. Therefore, complex dependency checking between instructions or data transfer logic is not required, and thus high control logic overhead is avoided. When a sufficient number of microthread slots (for example, 64 per NDP unit) for executing memory-bound kernels is used, memory bandwidth in a CXL memory expansion device may be largely utilized. When a μthread is completed, another μthread of a μthread pool is generated in an idle slot.

As described above, the NDP unit 1300 may include various scalar and vector functional units. For example, for efficiency, a width of a vector unit may match DRAM access granularity (for example, 32B in LPDDR5) in order to avoid a computation bottleneck. However, in other embodiments, the width of the vector unit may not match the DRAM access granularity.

Hereinafter, referring to FIG. 1 and FIG. 7 together, a cache hierarchy will be described.

In order to avoid complexity of cache coherence, a cache hierarchy of a GPU is adopted. An L1 data cache (L1 D $) of the NDP unit 1300 is read-only and uses a write-eviction policy. For example, an L0 instruction cache (L0 I $), an L1 instruction cache (L1 I $), and the L1 data cache may be configured as virtual caches and SRAM. The L1 data cache and the L1 instruction cache are physically separate from DRAM and store values fetched from DRAM so that the values may be accessed more quickly within the NDP unit 1300.

A capacity of the L1 data cache of the NDP unit 1300 may also be configured to be used by partitioning into a general L1 data cache and scratchpad memory. The L2 cache 1500 is arranged or disposed in front of a memory controller 1600 as illustrated in FIG. 1 in order to prevent cache coherence problems and also supports global memory atomic operations for data in DRAM. Since data-parallel, memory-bound workloads have relatively smaller instruction footprints than compute-bound workloads, the NDP unit 1300 uses a small instruction cache. In order to prevent access to old code, when an NDP kernel is unregistered through offset 1<<5 of FIG. 3, instruction caches are flushed. However, this occurs rarely and has negligible impact on performance.

As described above, in the microarchitecture of the NDP unit of the present disclosure, the above-described effects of the present disclosure may be obtained by newly proposing NDP sub-cores, a microthread generator, scratchpad memory, and a plurality of microthread slots of the NDP sub-core.

FIG. 8 is a diagram illustrating a structure of an NDP kernel according to an exemplary embodiment of the present disclosure.

FIG. 8 illustrates an example of an NDP kernel for a large-data reduction operation, and it may be assumed that scratchpad memory is mapped to 0x10000000 and a final result is stored at a location designated as 0x10000008 of the scratchpad memory. An AMOADD instruction may perform an atomic memory operation.

An NDP kernel may include an initializer, a kernel body, and a finalizer in order to support various use cases.

The initializer may be executed only once at an initial time before any μthread for the kernel body is generated. That is, the initializer may be executed only once when an NDP kernel is launched for initialization of scratchpad memory (that is, storing shared data to be used) (when required) and for any necessary pre-computation before a main computation. In the initializer, one μthread may be generated in each μthread slot by using a unique ID of an x2 (or offset) register. In another exemplary embodiment, one μthread slot is included per NDP unit, and only one μthread may be generated per NDP unit. In still another exemplary embodiment, even when a plurality of μthread slots are included in an NDP unit, only one μthread may be generated in the initializer. When the initializer is invoked, NDP kernel arguments may be available at a start address of scratchpad memory allocated to a kernel for each NDP unit 1300. An execution scheme of the initializer may be implemented in various schemes other than the above-described scheme.

After the initializer is completed, a μthread generator may start to generate μthreads for a μthread pool region given at a kernel start time in order to execute the kernel body. There may be a plurality of kernel bodies such that, when the kernel body is completed for all μthreads, all μthreads are generated again for a next kernel body. The kernel body may be executed once by each μthread generated to perform a main computation.

After execution of all kernel bodies (that is, when execution of all μthreads is completed), the finalizer is executed in the same scheme as the initializer or in a predetermined different scheme, but the finalizer may be executed to perform post-processing and to store, when required, a kernel-level output in memory (for example, DRAM).

Hereinafter, virtual memory and DRAM-TLB preloading will be described with reference to FIG. 2, FIG. 3, and FIG. 7 together.

An M²NDP architecture may efficiently support a virtual memory system. Since a CXL.mem protocol uses a host physical address for memory access, address translation is not required in a memory expansion device for general CXL.mem requests. However, a virtual address is provided for a μthread pool region, and NDP kernel code also uses a virtual address for memory access in a kernel. For example, as shown in FIG. 2, in order to perform one NDP operation corresponding to an NDP kernel launch request, an entire memory region may be divided into small units (for example, 0x20), and the small units are distributed and/or allocated to μthreads that are lightweight threads, thereby configuring a μthread pool. Each μthread is evenly distributed to NDP units 1300 and may execute a distributed/allocated portion within a given NDP operation for a memory region allocated to the corresponding μthread. Each μthread may be interpreted as having a cooperative relationship for performing one given NDP operation.

For example, when virtual memory is used, an L1 cache (a virtual cache using a virtual memory address) is accessed and referenced, and, when a miss occurs in the L1 cache, an L2 cache (a physical cache using a physical address) may be referenced. That is, when a miss occurs in the L1 cache, the L2 cache may be accessed using a physical address. Address translation through a TLB is required in order to access the L2 cache.

Accordingly, an NDP unit 1300 of the present disclosure may use a TLB of FIG. 7 for address translation. However, for an NDP kernel that processes a large amount of data in CXL memory expansion devices, an on-chip TLB may not be sufficient. Although CXL.io supports an ATS, performance may be degraded when an ATS is frequently used due to round-trip communication with a host and possible page table work (page table walk) in the host. Therefore, in order to cost-effectively improve a TLB reach of an NDP unit 1300 according to the present disclosure, a DRAM-TLB (L1 I TLB and L1 D TLB) is adopted, thereby minimizing a miss penalty of on-chip TLBs.

According to the present disclosure, as a process for accessing the L2 cache, when a miss occurs in an L1 instruction cache, an L1 instruction TLB (L1 I TLB) is first accessed, and, when a miss occurs in the L1 instruction TLB, a DRAM-TLB may be accessed. When a miss occurs in the DRAM-TLB, information may be requested from a host by using an ATS. Likewise, when a miss occurs in an L1 data cache, an L1 data TLB (L1 D TLB) is accessed, and, when a miss occurs in the L1 data TLB, a DRAM-TLB is accessed, and, when a miss occurs in the DRAM-TLB, information on address translation should finally be requested from a host by using the above-described ATS.

In an exemplary embodiment of the present disclosure, only an L1 (I/D) TLB is described as being used, but in another exemplary embodiment, TLBs configured in a plurality of layers may be used. For example, an L1 (I/D) TLB, an L2 (I/D) TLB, an L3 (I/D) TLB, and so on may be included, and, when a miss occurs in an L1 TLB, an L2 TLB is accessed, and, when a miss occurs in the L2 TLB, an L3 TLB is accessed, thereby using the present disclosure. For example, when an L3 TLB is a last TLB and a miss occurs in the L3 TLB, a DRAM-TLB may be accessed. When a miss occurs in the DRAM-TLB, information may be requested from a host by using an ATS.

Each DRAM-TLB entry may use 16 bytes to store an ASID, a tag, a physical page number, and other attributes (for example, permission bits). When a plurality of CXL memories exist in a system, in order to localize DRAM-TLB access, a DRAM-TLB entry may be placed in the same CXL memory as a page mapping. A physical location L of a DRAM-TLB entry for a virtual page number (VPN) may be simply obtained as shown in Equation 1 below.

$$L = Base + ( ( VPN ⊕ ASID ) ≪ {log}_{2} S ) mod R \qquad [ Equation 1 ]$$

S may be a TLB entry size (in bytes), R may be a size of a region allocated to a DRAM-TLB, and Base may be a physical base address of the DRAM-TLB. In order to support a plurality of page sizes, the present disclosure may use a POM-TLB approach that partitions DRAM-TLBs for various page sizes and determines a partition to be accessed first by using a highly accurate page size predictor.

A DRAM-TLB may be implemented with low overhead. Even at a smallest 4 KB page size, an overhead of DRAM-TLB entry storage is only 16 B/4 KB=0.4%, and, in a 2 MB page, an overhead may be negligibly small. When a size of a DRAM-TLB region is sufficient such that a TLB reach is adjusted to be similar to a memory capacity of a CXL memory expansion device, after a DRAM-TLB is warmed up, a DRAM-TLB miss may hardly occur in a hashed location calculation.

In addition, in order to prevent an initial burst of cold DRAM-TLB misses, when data of an application including an NDP operation is first loaded to a memory expansion device (for example, when an embedding table of a recommendation model is loaded to a CXL memory expansion device) or in association with a start of loading data of an application, entries of a DRAM-TLB corresponding to a predetermined virtual address range may be preloaded into the DRAM-TLB. As shown in FIG. 3, for efficient DRAM-TLB preloading, an OS may provide a system call that receives a virtual address range, identifies, by using M²func, whether a request is a DRAM-TLB preloading request based on a memory address of a first request, and preloads DRAM-TLB entries. When such OS support is not provided, a user may implement an NDP kernel that touches all pages of a given virtual address range, thereby generating DRAM-TLB misses and performing preloading. When a DRAM-TLB miss occurs later, translation information may be obtained by using an ATS and a DRAM-TLB entry may be filled. A host may also invalidate both on-chip TLBs and DRAM TLBs by using M²func for TLB shootdown.

CXL-M²NDP on-chip TLBs and DRAM TLBs may maintain address translation information for address regions mapped to other CXL memory expansion devices when other CXL memory expansion devices exist. When a page mapping is changed, TLB shootdown should be performed for all CXL-M²NDPs, but such a change may hardly occur in in-memory data assumed in the present disclosure (for example, no swap to a disk).

Meanwhile, as shown in FIG. 1, it may be assumed that a plurality of memory expansion devices are used. By using direct P2P access between CXL devices through a CXL switch 300, NDP kernels may access data of other CXL-M²NDPs to process large data. However, since a CXL interface bandwidth may become a bottleneck for frequent P2P access, storing data divided across a plurality of CXL memory expansion devices should be carefully performed. Since various workloads show various memory access patterns, data partitioning schemes are generally specialized for target workloads. For best performance, current multi-GPU systems also require user-level software that partitions data across GPUs and executes separate kernels. Thus, it may be similarly assumed that data is placed in CXL memory expansion devices by software and an NDP kernel is launched at each CXL-M²NDP for multi-device scaling. However, since NDP units may directly access other CXL memory expansion devices for reads and atomic operations similar to a GPU, data location does not need to be perfectly identified. Although CXL 3.0 allows fine-grained address interleaving across CXL memory expansion devices, the present disclosure may assume page-granularity data placement across CXL memory expansion devices by a user in order to increase locality of data access.

FIG. 9 is a diagram illustrating a system using M²func according to an exemplary embodiment of the present disclosure.

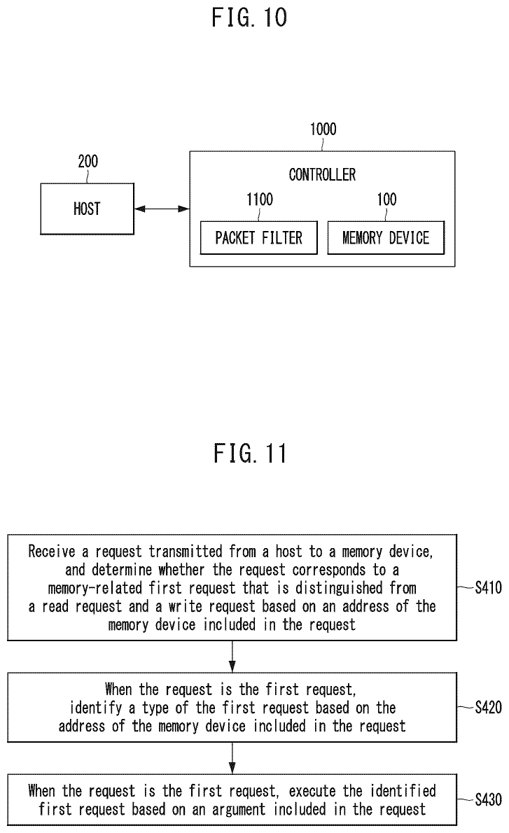

FIG. 10 is a diagram illustrating a system using M²func according to another exemplary embodiment of the present disclosure.

FIG. 11 is a flowchart illustrating a data processing method for a memory expansion device using M²func according to an exemplary embodiment of the present disclosure.

Hereinafter, description will be made with reference to FIGS. 9 to 11 together.

As shown in FIG. 9, a controller 1000 may be arranged or disposed between a host 200 and a memory device 100. The memory device 100 may be a DRAM or a flash memory (for example, an SSD). In another exemplary embodiment, as shown in FIG. 10, a memory element (for example, a memory buffer (SRAM)) in the controller 1000 may function as a memory device. In still another exemplary embodiment of the present disclosure, a controller may be implemented to be included in a memory device.

A configuration for M²func may be a configuration required for communication between the host 200 and a memory expansion device.

An execution process of M²func by the controller 1000 may include operation S410 to operation S430.

In operation S410, the controller 1000 may receive a request transmitted from the host 200 to the memory device 100, and determine, based on an address of the memory device 100 included in the request, whether the request corresponds to a memory-related first request distinguished from a read request and a write request. The memory-related first request may refer to requests for functions having various offsets shown in FIG. 3, and a type of the function is not limited thereto. The address of the memory device may be, for example, an address mapped to a DRAM, an address mapped to a memory buffer in the controller 1000, or an address mapped to a flash memory.

In operation S420, based on the request being the first request, the controller 1000 may identify a type of the first request based on the address of the memory device 100 included in the request.

In operation S430, based on the request being the first request, the controller 1000 may execute the identified first request based on an argument included in the request (for example, an argument of v1 of FIG. 2).

After determining that the request corresponds to the first request, when the controller 1000 determines that an additional read request for an address of the first request is received, the controller 1000 may transmit, to the host 200, a processing status of the first request stored at the address of the first request in the memory device 100. The read request may be for confirming whether the first request (that is, a function call) is normally performed. The processing status may refer to, as shown in FIG. 3, result data of executing a kernel, or function completion/in progress, or function success/error, etc., or the like.

The controller 1000 may include a packet filter 1100.

The controller 1000 may allocate and store, in the controller 1000, an address region for distinguishing the first request. That is, the address region for distinguishing the first request may be allocated and stored in the packet filter 1100. Operation S410 may include determining that the request corresponds to the first request based on an address included in the request being included in the address region. Operation S410 may be executed in the packet filter 1100 of the controller 1000. For example, as shown in FIG. 2, when the address region of the packet filter 1100 is allocated, addresses of 0x10000 to 0x1FFFF of a first record may be allocated as an address region mapped to a DRAM, addresses of 0x20000 to 0x2FFFF of a second record may be allocated as an address region mapped to a memory buffer in the controller 1000, and addresses of 0x30000 to 0x3FFFF of a third record may be allocated as an address region mapped to a flash memory. The above-described contents are only one example, and an address region may be allocated by mapping an address to various memory types in various schemes.

The present disclosure is characterized in that an argument for a function is included in the request (that is, data of a packet).

A fence instruction may be included between the first request and the additional read request for the address of the first request.

When allocating, to the packet filter, the address region for distinguishing the first request and receiving the request, a predetermined protocol may be used. The predetermined protocol may be a CXL.mem protocol, or may be, for example, another protocol similar to CXL, such as CCIX.

When allocating, to the packet filter 1100, the address region for distinguishing the first request, a predetermined first protocol from the host 200 (for example, a CXL.io protocol, a CXL.mem protocol for using M²func, or another protocol similar to CXL) is used, and, when receiving the request from the host 200, a predetermined second protocol (for example, a CXL.mem protocol, or another protocol similar to CXL) may be used.

According to the present disclosure, an overhead may be reduced by using the above-described configuration for M²func.

In the related art, when M²func is not used, a function call cannot be performed only by a store instruction, but, according to the present disclosure, since M²func is used, the host may transfer function arguments for a function type only by a simple store instruction.

According to the present disclosure, host hardware 200 may not transmit, to the controller 1000, a request by distinguishing various functions of M²func, for example, kernel registration, kernel launch, DRAM-TLB entry preload, etc., or the like. When the host hardware 200 distinguishes the various functions, the host hardware may need to be modified, and this is a great constraint. Therefore, the present disclosure is characterized in that M²func is used through distinction at a software-level step of a user (for example, a developer), and modification of the host hardware is not required.

According to the present disclosure, not only functions for NDP shown in FIG. 3, but also communication with a host through existing PCIe (for example, communication for reading and writing a file in an SSD) may be replaced with the configurations for M²func of the present disclosure. That is, the present disclosure may provide a greater effect when fine-grained communication tasks are requested.

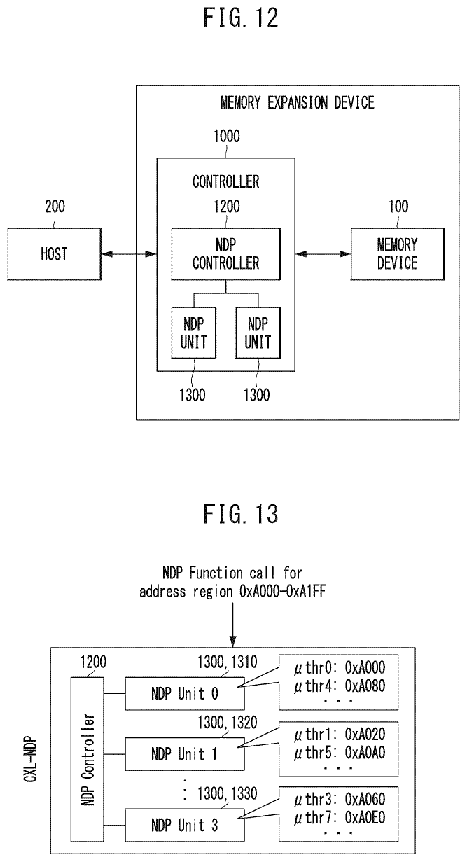

FIG. 12 is a diagram illustrating a system using only M²μthr without using M²func according to an exemplary embodiment of the present disclosure.

FIG. 13 is a diagram illustrating a case using only M²μthr without using M²func according to an exemplary embodiment of the present disclosure.

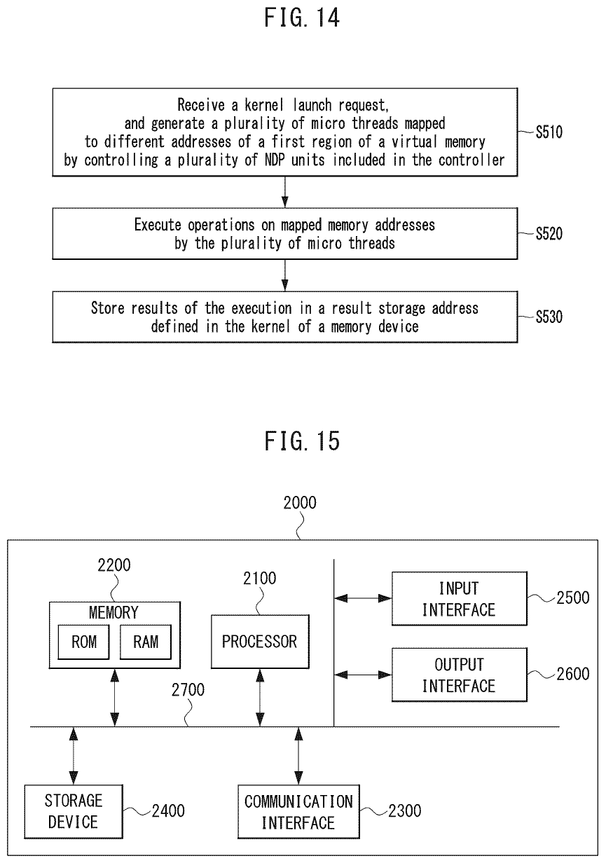

FIG. 14 is a flowchart illustrating a data processing method for a memory expansion device using M²μthr according to an exemplary embodiment of the present disclosure.

Hereinafter, description will be made with reference to FIGS. 12 to 14 together.

A memory expansion device may include a memory device 100 and a controller 1000.

The controller 1000 may include an NDP controller 1200 and a plurality of NDP units 1300. In the exemplary embodiment of FIG. 13, it may be assumed that a packet filter 1100 is not included in a CXL controller 1000.

A memory expansion device, specifically, a CXL controller 1000, may receive an NDP function request from a host 200 through, for example, PCIe or a CXL.io protocol, etc., or the like.

For example, the request may be a request to execute an NDP function for a memory region of 0xA000 to 0xA1FF. The request may include synchronization/asynchronization information, a kernel ID, a μthread pool region base and bound, an argument size, NDP kernel arguments, etc., or the like. An address of the μthread pool region and an address of the NDP kernel arguments may be addresses included in a virtual memory region.

In operation S510, when the controller 1000 receives an operation request (a kernel launch request), the controller 1000 may control the plurality of NDP units 1300 included in the controller 1000 to generate a plurality of microthreads mapped to different addresses of a first region base and bound of the virtual memory.

In operation S520, the controller 1000 may cause each of the microthreads to execute an operation for a mapped memory address.

In operation S530, the controller 1000 may store an executed result at a result storage address defined in the kernel of the memory device. The result storage address defined in the kernel may be an address of the memory device 100. The controller 1000 may further include a memory controller, and the executed result may be stored in the memory device 100 through the memory controller.

For example, in order to perform one NDP operation corresponding to an NDP kernel launch request, the NDP controller 1200 of the controller 1000 may divide a memory region of 0xA000 to 0xA1FF into small units (for example, 0x20) and distribute and/or allocate each small unit to a μthread, which is a lightweight thread, to configure a μthread pool. Each μthread is evenly distributed to the NDP units 1300 and may execute a distributed/allocated portion in a given NDP operation for a virtual memory region allocated to each μthread. Each μthread may be interpreted as having a cooperative relationship in order to perform one given NDP operation. For example, μthread0, μthread4, etc., or the like, may be distributed to an NDP unit 1310, μthread1, μthread5, etc., or the like, may be distributed to an NDP unit 1320, and μthread3, μthread7, etc., or the like, may be distributed to an NDP unit 1340. For example, a virtual memory address of μthread0 may be 0xA000, and a virtual memory address of μthread1 may be 0xA020.

For example, an execution result of a kernel operation of μthread0 may be stored at a virtual memory address of μthread0, for example, 0xA000.

All microthreads executed in any one NDP unit among the plurality of NDP units 1300 may share data with each other through at least one on-chip scratchpad memory among on-chip scratchpad memories included in each of the plurality of NDP units 1300. When a kernel launch is completed, an operation result may be temporarily stored in the on-chip scratchpad memory, and then the on-chip scratchpad memory may be cleared.

The controller 1000 may further include a DRAM-TLB for converting a virtual address of the virtual memory into a physical address of the memory device 100. For example, the virtual address of the virtual memory may refer to an address of a first region of the virtual memory to which a μthread is mapped, may refer to an address of another region other than the first region of the virtual memory used by the μthread, or may refer to an address of the NDP kernel arguments in another region of the virtual memory.

For this purpose, a CXL.io protocol may be used, but M²func through a CXL.mem protocol may be used, and M²func has been described with reference to FIG. 11. That is, the controller 1000 may receive a request transmitted from the host 200 to the memory device 100, and determine, based on an address of the memory device 100 included in the request, whether the request corresponds to a memory-related first request distinguished from a read request and a write request. When the request is the first request, the controller 1000 may identify a type of the first request based on the address of the memory device 100 included in the request, and, when the request is the first request, the controller 1000 may execute the identified first request based on an argument included in the request. When the request is a DRAM-TLB preloading request among types of the first request, the DRAM-TLB may be used by preloading the DRAM-TLB.

In the exemplary embodiments of FIGS. 12 to 14, a case when M²μthr is used without using M²func has been described. When M²func is used together with M²μthr, the first request may be, for example, a request for kernel launch corresponding to an offset 2<<5 of FIG. 3.

Since CXL.io uses a physical design and a protocol stack of PCIe, CXL.io is expected to have similar performance characteristics. Computation offloading through PCIe includes multiple software and hardware steps that may incur significant overhead in terms of latency and host processor usage, particularly for fine-grained offloading.

For example, in order to start a GPU kernel, a user-mode CUDA/OpenCL runtime and a kernel-mode GPU device driver are required. The runtime writes a kernel launch GPU command in a user buffer, and the driver pushes a packet indicating the GPU command to a ring buffer in a kernel space. Then, the host updates a head pointer of the ring buffer to notify the GPU of a new command, and this causes additional latency through PCIe. Overall, kernel execution may take a latency of several μs (for example, about 4.5 μs). Polling or an interrupt may be used to confirm kernel completion, and both consume additional host processor cycles. Polling may incur an overhead of 2 to 3 μs, and an interrupt has a similar or higher overhead depending on a bottom-half mechanism used. Thus, a total latency of kernel launch and completion confirmation may be much longer than 5 μs or 10,000 cycles on a 2 GHz CPU. Such a latency may be tolerable for coarse-grained NDP offloading, but may be too high for latency-sensitive fine-grained NDP kernels. Thus, in order to solve the above-described problem, the present disclosure may provide a low-overhead offloading mechanism based on CXL.mem, which may be effective for both fine-grained offloading and coarse-grained offloading.

While CXL.io may have a high overhead for frequent and fine-grained communication, CXL.mem messages may be transmitted with low latency and low CPU usage. A current CXL.mem protocol defines multiple unused bits in a packet format. Thus, it may be considered to use bits to encode information required to implement special functions not defined in the standard (for example, NDP management).

However, in order to enable such customized communication, host processor hardware should be modified to support special use of reserved bits. Thus, such customized communication cannot be utilized in commodity processors supporting only standard protocols. Also, in order to transmit special packets, a special instruction should be introduced into an ISA of the host, similar to related arts. Properly extending a standard protocol or an ISA of the host hinders wide adoption.

Thus, as described above, the present disclosure may provide an NDP architecture based on an unmodified CXL.mem protocol for best compatibility with various host processors. It may be assumed that data to be processed in NDP is stored in a CXL memory expansion device. For data in a local memory of a host, the host has high-bandwidth access rights to the data, and NDP is not necessary.

Meanwhile, the present disclosure may provide a novel M²NDP (Memory-Mapped NDP) architecture for general-purpose NDP of low-overhead CXL memory. As described above, M²NDP may provide two main mechanisms, that is, M²func for low-overhead communication between the host 200 and a CXL memory expansion device, and M²μthr for cost-effective NDP kernel execution.

CXL.io may be used for various communications between a host and CXL memory (for example, an NDP offload command), but a protocol stack generates higher overhead than CXL.mem and requires an expensive kernel level in a host, thereby wasting CPU cycles. Meanwhile, CXL.mem has low latency and may be used without kernel intervention, but supports only basic memory read/write transactions.

The present disclosure may provide M²func that selectively repurposes read and write packets defined in CXL.mem for efficient host-device communication beyond memory transactions. By encapsulating NDP management commands (for example, function calls) of CXL.mem requests into predetermined addresses, high overhead of CXL.io may be avoided. A key enabling element of M²func is a packet filter 1100 arranged or disposed at an input port of a CXL memory expansion device. The packet filter may check whether a memory address of an incoming request matches a memory range preallocated for each host process. Then, for a matching request, various NDP management functions may be triggered according to the address. Accordingly, NDP management function calls (for example, kernel registration, execution, and status polling) may be simply performed by executing memory accesses at a host 200. As a result, particularly in fine-grained NDP, high overhead of a CXL.io protocol stack and kernel operations for low-overhead NDP offloading may be avoided. In addition, modification of a CXL.mem standard is not required for best compatibility with a host CPU. When CXL.io is used, overhead occurs due to passing through an OS, whereas M²func may be directly used in a user space. In addition, M²func may be used not only for functions basically supported for M²NDP but also for various functions on a CXL device (for example, storage and network access), thereby providing high generality.

In addition, the present disclosure may provide M²μthr for intuitive abstraction and cost-effective NDP. Memory-bound workloads tend to use fewer registers than compute-bound workloads. Accordingly, the present disclosure may provide μthreads, which are lightweight threads including a subset of architectural registers as an execution unit. By reducing register usage, an NDP unit may execute many μthreads simultaneously to hide DRAM access latency without excessive physical register file cost. In addition, memory-bound data-parallel workloads may generally be implemented such that each thread is associated with specific data to be processed. In existing programming environments such as CUDA, an association between threads and memory locations is indirectly expressed through code (for example, index calculation of an array element for a thread using a thread block ID, a block dimension, and a thread ID in CUDA). In contrast, when M²μthr is used, each μthread is generated in direct association with a specific memory location. That is, a μthread is memory-mapped. As a result, initial address calculation code in a kernel may be eliminated. Although a scheduling and execution scheme in hardware has a similarity to a CUDA warp, a CUDA warp basically supports only a SIMD (vector) scheme in which all threads therein are executed, whereas μthreads basically support vector instructions in a scalar thread, so that both scalar operations and vector operations may be used as required without wasting resources.

An architecture of an NDP unit 1300 of the present disclosure is based on a RISC-V ISA including vector extension supporting scalar operations in order to avoid redundant address calculation in a SIMT-only GPU while fully utilizing DRAM bandwidth in a CXL memory expansion device at low cost by using SIMD functional units. Many memory-mapped μthreads are executed through FGMT (Fine-Grained Multithreading) to hide memory access latency. In addition, data may be shared in on-chip scratchpad memory providing a wider scope than shared memory of a GPU, thereby reducing DRAM traffic. Unlike thread block generation of a GPU, which may waste resources due to divergence among warps, μthreads are generated individually.

In addition, in order to provide flexibility for various workloads, the M²NDP architecture supports virtual memory. However, address translation may cause significant overhead in NDP because page table entries should be accessed at a host 200 through ATS (Address Translation Service) via CXL.io. In order to avoid the overhead, a DRAM-TLB is used in a CXL memory expansion device. In the present disclosure, since cold misses of the DRAM-TLB may be severe, DRAM-TLB preloading by an operating system using M²func may also be provided. According to the present disclosure, efficiency of M²NDP for various workloads may be provided with significant performance improvement of up to 171× and energy reduction of 81.3% compared with a host processor having a passive CXL memory expansion device.

By combining M²func and M²μthr and utilizing OS support, the M²NDP architecture of the present disclosure enables low-overhead general-purpose NDP in a CXL memory expansion device. Efficiency of the design may be demonstrated through various workloads such as in-memory online analytic processing (OLAP), deep-learning recommendation model (DLRM), graph workloads, and important kernels of large language models (LLM).

M²NDP achieves up to 171× speed improvement for various workloads while reducing energy consumption by up to 94.2% compared with a baseline system using a passive CXL memory expansion device.

A controller and/or memory expansion device of the present disclosure may be applied to generative AI such as ChatGPT, data centers, cloud computing, big data and analytics, in-memory online analytic processing (OLAP), recommendation systems, and graph analytics processing.

FIG. 15 is a conceptual diagram illustrating an example of a generalized controller, a memory expansion device, or a computing system capable of performing at least some of processes of FIGS. 1 to 14.

At least a portion of processes of a data processing method for a memory expansion device according to an exemplary embodiment of the present disclosure may be executed by a computing system 2000 of FIG. 15.

As shown in FIG. 15, the computing system 2000 according to an embodiment of the present disclosure may be configured to include a processor 2100, a memory 2200, a communication interface 2300, a storage device 2400, an input interface 2500, an output interface 2600, and a bus 2700.

The computing system 2000 according to an embodiment of the present disclosure may include at least one processor 2100 and the memory 2200 storing program instructions instructing the at least one processor 2100 to perform at least one process step. At least some of the operations or process steps of the method according to an embodiment of the present disclosure may be performed by the at least one processor 2100 loading and executing the program instructions in the memory 2200.

The processor 2100 may include a central processing unit (CPU) or a graphics processing unit (GPU) or may be implemented by another kind of dedicated processor suitable for performing the method of the present disclosure.

Each of the memory 2200 and the storage device 2400 may be comprised of one or more of a volatile storage medium or a non-volatile storage medium. For example, the memory 2200 may be comprised of one or more of a read only memory (ROM) or a random access memory (RAM).

Additionally, the computing system 2000 may include the communication interface 2300 performing communications through a wireless communication network.

Additionally, the computing system 2000 may further include the storage device 2400, the input interface 2500, and the output interface 2600.

The components of the computing system 2000 may be connected to each other by the system bus 2700 to communicate with each other.

The computing system 1000 according to an exemplary embodiment of the present disclosure may be any data processing device capable of communications through a network such as a desktop computer, a laptop computer, a notebook PC, a smartphone, a tablet PC, a mobile phone, a smart watch, smart glasses, an e-book reader, a portable multimedia player (PMP), a portable game console, a navigation device, a digital camera, a digital multimedia broadcasting (DMB) player, a digital audio recorder, a digital audio player, a digital video recorder, a digital video player, and a personal digital assistant (PDA).

The device and method according to exemplary embodiments of the present disclosure may be implemented by computer-readable program codes or instructions stored on a computer-readable intangible recording medium. The computer-readable recording medium includes all types of recording device storing data which may be read by a computer system. The computer-readable recording medium may be distributed over computer systems connected through a network so that the computer-readable program or codes may be stored and executed in a distributed manner.

The computer-readable recording medium may include a hardware device specially configured to store and execute program instructions, such as a ROM, RAM, and flash memory. The program instructions may include not only machine language codes generated by a compiler, but also high-level language codes executable by a computer using an interpreter or the like.

Some aspects of the present disclosure described above in the context of the device may indicate corresponding descriptions of the method according to the present disclosure, and the blocks or devices may correspond to operations of the method or features of the operations. Similarly, some aspects described in the context of the method may be expressed by features of blocks, items, or devices corresponding thereto. Some or all of the operations of the method may be performed by (or using) a hardware device such as a microprocessor, a programmable computer, or electronic circuits, for example. In some exemplary embodiments, one or more of the most important operations of the method may be performed by such a device.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure may be merely exemplary in nature and, thus, variations that do not depart from the substance of the disclosure may be intended to be within the scope of the disclosure. Such variations may not be to be regarded as a departure from the spirit and scope of the disclosure. Thus, it will be understood by those of ordinary skill in the art that various changes in form and details may be made without departing from the spirit and scope as defined by the following claims.

What is claimed is:

1. A memory expansion controller configured to:
receive a request transmitted from a host to a memory device, and determine, based on an address of the memory device included in the request, whether the request corresponds to a memory-related first request distinguished from a read request to the memory device and a write request to the memory device;
identify, based on the request being the first request, a type of the first request based on the address of the memory device included in the request; and
execute, based on the request being the first request, the identified first request based on an argument included in the request.

2. The memory expansion controller of claim 1, wherein the type of the first request includes one or more of a Near Data Processing (NDP) kernel or an operation related to a Translation Lookaside Buffer (TLB) other than the memory device or a DRAM-TLB.

3. The memory expansion controller of claim 1, after determining that the request corresponds to the first request, configured to transmit, based on determining that an additional read request for an address of the first request is received, to the host, a processing status of the first request stored at the address of the first request in the memory device.

4. The memory expansion controller of claim 1, comprising a packet filter,
wherein an address region for distinguishing the first request is allocated and stored in the packet filter, and
wherein the packet filter is configured to determine that the request corresponds to the first request based on an address included in the request being included in the address region.

5. The memory expansion controller of claim 4, wherein a predetermined protocol is used based on allocating, to the packet filter, the address region for distinguishing the first request and receiving the request.

6. The memory expansion controller of claim 4, wherein:
a predetermined first protocol from the host is used based on allocating, to the packet filter, the address region for distinguishing the first request, and
a predetermined second protocol is used based on receiving the request from the host.

7. The memory expansion controller of claim 1, comprising:
an NDP controller configured to execute the first request; and
a plurality of NDP units controlled by the NDP controller,
wherein, based on the first request being a kernel launch request,
the NDP units generate a plurality of microthreads mapped to different addresses of a first region of virtual memory, and
each microthread executes an operation on a mapped memory address.

8. The memory expansion controller of claim 7, wherein all microthreads executed within an NDP unit from among the plurality of NDP units share data with each other through at least one on-chip scratchpad memory from among on-chip scratchpad memories included in each of the plurality of NDP units.

9. The memory expansion controller of claim 1, further comprising a DRAM-TLB configured to convert a virtual address of virtual memory into a physical address of the memory device to execute a Near Data Processing (NDP) kernel,
wherein, based on the request corresponding to a DRAM-TLB preloading request from among the types of the first request, the DRAM-TLB is used by preloading a DRAM-TLB entry.

10. A memory expansion device, comprising:
a memory device; and
a controller arranged between a host and the memory device and including a plurality of Near Data Processing (NDP) units,
wherein, based on a kernel launch request received by the controller,
the NDP units generate a plurality of microthreads mapped to different addresses of a first region of virtual memory,
each microthread executes an operation on a mapped memory address, and
a result of the execution is stored at a result storage address of the memory device defined in a kernel launched by the kernel launch request.

11. The memory expansion device of claim 10,
wherein, based on the kernel launch request received by the controller,
the NDP units generate a plurality of microthreads distributed and mapped to different addresses of a first region of virtual memory to perform an NDP operation corresponding to the kernel launch request.

12. The memory expansion device of claim 10, wherein all microthreads executed within an NDP unit from among the plurality of NDP units share data with each other through at least one on-chip scratchpad memory from among on-chip scratchpad memories included in each of the plurality of NDP units.

13. The memory expansion device of claim 10, wherein the controller is configured to:
receive a request transmitted from the host to the memory device, and determine, based on an address of the memory device included in the request, whether the request corresponds to a memory-related first request distinguished from a read request and a write request,
identify, based on the request being the first request, a type of the first request based on the address of the memory device included in the request, and
execute, based on the request being the first request, the identified first request based on an argument included in the request.

14. A memory expansion device, comprising:
a memory device; and
a controller arranged between a host and the memory device and including a plurality of Near Data Processing (NDP) units,
wherein the NDP units include a DRAM-Translation Lookaside-Buffer (DRAM-TLB) configured to convert a virtual address of virtual memory into a physical address of the memory device, and
wherein the controller is configured to preload, based on a request transmitted from the host to the memory device corresponding to a DRAM-TLB preloading request distinguished from a read request to the memory device and a write request to the memory device, an entry of the DRAM-TLB corresponding to a predetermined virtual address range into the DRAM-TLB in association with a start of loading data of an application.

15. The memory expansion device of claim 14, wherein the controller is further configured to identify that the request transmitted from the host to the memory device corresponds to the DRAM-TLB preloading request based on an address of the memory device included in the request transmitted from the host to the memory device.
